(19) United States
(12) Patent Application Publication
(10) Pub. No.: US 2023/0327782 A1
(43) Pub. Date: Oct. 12, 2023

(54) HYDRAULIC DEVICE MEASUREMENT APPARATUS, HYDRAULIC DEVICE MEASUREMENT SYSTEM, AND HYDRAULIC DEVICE MEASUREMENT METHOD

(71) Applicants: KABUSHIKI KAISHA TOSHIBA, Tokyo (JP); TOSHIBA ENERGY SYSTEMS & SOLUTIONS CORPORATION, Kawasaki-shi (JP)

(72) Inventors: Tatsuro UCHIDA, Chofu Tokyo (JP); Masahiko NAKAZONO, Kawasaki Kanagawa (JP)

(73) Assignees: KABUSHIKI KAISHA TOSHIBA, Tokyo (JP); TOSHIBA ENERGY SYSTEMS & SOLUTIONS CORPORATION, Kawasaki-shi (JP)

(21) Appl. No.: 18/158,806

(22) Filed: Jan. 24, 2023

(30) Foreign Application Priority Data
Apr. 12, 2022 (JP) 2022-065746

(51) Int. Cl. H04B 13/02; G01L 1/22; F15B 19/00

(52) U.S. Cl. CPC H04B 13/02; F15B 19/00; G01L 1/2262

(57) ABSTRACT

According to the present embodiment, a hydraulic device measurement apparatus comprises a first wireless communication portion, and a second wireless communication portion. A transmitter and a receiver of the first wireless communication portion are arranged along the rotation axis of the rotating portion, and a transmitter and a receiver of the second wireless communication portion are arranged in the air along the rotation axis. The first wireless communication portion and the second wireless communication portion transmit and receive the transfer signal along the rotation axis of the rotating portion.

### CROSS-REFERENCE TO RELATED APPLICATIONS

This application is based upon and claims the benefit of priority from the prior Japanese Patent Application No. 2022-065746, filed on Apr. 12, 2022 the entire contents of which are incorporated herein by reference.

### FIELD

The embodiments of the present invention relate to a hydraulic device measurement apparatus, a hydraulic device measurement system, and a hydraulic device measurement method.

### BACKGROUND

In order to ascertain deformation or the like of the internal structure of turbo fluid machinery represented by a water turbine and a pump, measurement is performed on the surface of the structure, using a strain gauge or a pressure sensor. Targets of such measurement of deformation of the internal structure include positive displacement fluid machinery represented by a gear pump and a screw pump, various fluid machinery such as a heat exchanger, and blades arranged, for example, inside a simple pipe. Further, when a flow is visualized in these devices, image capturing and image analysis are performed using an imaging device, whereby device integrity is quantitatively evaluated.

Transfer of such measurement data from an underwater rotation side to a non-rotating side in air is generally performed as contact transfer via a partition that separates the underwater side and the air side from each other or data transfer by contactless proximity wireless communication.

### BRIEF DESCRIPTION OF THE DRAWINGS

FIG. 1 is a diagram illustrating a configuration example of a hydraulic device measurement system;

FIG. 2 is a diagram illustrating a configuration example of a first wireless communication portion;

FIG. 3 is a diagram illustrating a configuration example of a second wireless communication portion;

FIG. 4 is a perspective view of a hydraulic device measurement system illustrated in FIG. 2;

FIG. 5 is a diagram illustrating a configuration example of a hydraulic device measurement system according to a second embodiment;

FIG. 6 is a diagram illustrating a configuration example of a hydraulic device measurement system according to a first modification of the second embodiment;

FIG. 7 is a diagram illustrating an example of horizontal rotation of a driving portion;

FIG. 8 is a diagram illustrating a configuration example of a hydraulic device measurement system according to a second modification of the second embodiment;

FIG. 9 is a diagram illustrating a configuration example of a hydraulic device measurement system according to a third embodiment;

FIG. 10 is a diagram illustrating a configuration example of a light guide tube;

FIG. 11 is a diagram illustrating a configuration example of a hydraulic device measurement system according to a fourth embodiment;

FIG. 12 is a diagram illustrating a configuration example of a hydraulic device measurement system according to a fifth embodiment; and

FIG. 13 is a diagram illustrating a state where laser light is emitted through a cylindrical lens.

### DETAILED DESCRIPTION

A hydraulic device measurement apparatus, a hydraulic device measurement system, and a hydraulic device measurement method according to the embodiments of the present invention will be explained below in detail with reference to the accompanying drawings. The embodiments described below are only examples of the embodiments of the present invention and the present invention is not limited to the embodiments. In the drawings referred in the embodiments, same parts or parts having identical functions are denoted by like or similar reference characters and there is a case where redundant explanations thereof are omitted. Further, for convenience of explanation, there are cases where dimensional ratios of the parts in the drawings are different from those of actual products and some part of configurations is omitted from the drawings.

### First Embodiment

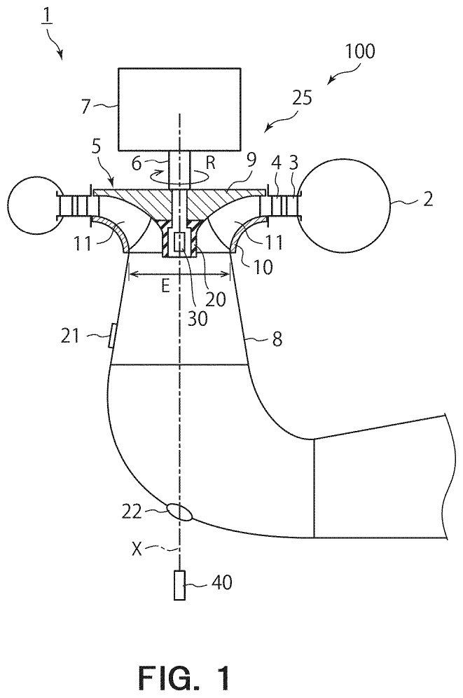

A hydraulic device measurement system according to a first embodiment of the present invention is described below with reference to FIGS. 1 to 4. In the present embodiment, a case of ascertaining strain and stress of a runner and an internal flow in a Francis turbine is described as an example.

FIG. 1 is a diagram illustrating a configuration example of a hydraulic device measurement system. As illustrated in FIG. 1, a hydraulic device measurement system 1 can transfer measurement data related to a Francis turbine 100 from an underwater rotation side to an air side. The hydraulic device measurement system 1 includes a hydraulic device measurement apparatus 25 and the Francis turbine 100. A schematic diagram of a cross-section of the Francis turbine 100 is illustrated in FIG. 1. Although the hydraulic device measurement system 1 according to the present embodiment includes the Francis turbine 100, the configuration of the system 1 is not limited thereto. For example, the hydraulic device measurement system 1 may be another system including a rotating body rotating in a liquid about a rotation shaft.

### (Francis Turbine)

First, the Francis turbine 100 is described. The Francis turbine 100 is an example of hydraulic machinery and includes a spiral casing 2 into which water flows from an upper reservoir through a penstock (both not illustrated) during turbine operation, a plurality of stay vanes 3, a plurality of guide vanes 4, a runner 5, and a runner cone 20.

The stay vanes 3 are configured to guide the water flowing into the casing 2 to the guide vanes 4 and the runner 5 and arranged at predetermined intervals in the circumferential direction. A channel through which the water flows is formed between the stay vanes 3.

The guide vanes 4 are configured to guide the water flowing thereinto to the runner 5 and arranged at predetermined intervals in the circumferential direction. A channel through which the water flows is formed between the guide vanes 4. Each guide vane 4 is pivotally movable. Each guide vane 4 is pivotally moved to change the degree of opening of the guide vanes 4, whereby the flow rate of the water flowing into the runner 5 can be adjusted. In this manner, the output of a power generator 7 described later can be adjusted.

The runner 5 is rotatable about the axis of rotation X relative to the casing 2. The runner 5 is driven to be rotated about the axis of rotation X in a rotation direction R by the water flowing thereinto from the casing 2 during turbine operation. That is, the runner 5 converts pressure energy of the water flowing thereinto to rotational energy. The runner 5 includes a crown 9 coupled to a main shaft 6, a band 10 provided on the outer circumference side of the crown 9, and a plurality of runner blades 11 provided between the crown 9 and the band 10. The runner blades 11 are arranged at predetermined intervals in the circumferential direction and are each joined to the crown 9 and the band 10. A channel (an inter-blade channel) through which the water flows is formed between the runner blades 11. Further, the runner cone 20 is provided at the center of the crown 9.

The runner cone 20 has a truncated cone portion in the shape of, for example, a circular truncated cone. The truncated cone portion has a shape of a circular truncated cone with the outer diameter reduced downstream. The upstream end of the truncated cone portion is coupled to the center of the crown 9 via a coupling portion. The truncated cone portion is fixed to the crown 9 with, for example, a bolt. Accordingly, the runner cone 20 is also rotated about the axis of rotation X in the rotation direction R with rotation of the runner 5. Further, the inside of the truncated cone portion is hollow. As illustrated in FIG. 1, the inner diameter at the upstream end of the truncated cone portion may be smaller than the inner diameter at the downstream end of the truncated cone portion.

The power generator 7 is coupled to the runner 5 via the main shaft 6. During turbine operation, the rotational energy of the runner 5 is transmitted to the power generator 7, whereby the power generator 7 generates power.

The power generator 7 may be configured to also serve as an electric motor and drive and rotate the runner 5 by receiving power supply. In this case, water in a lower reservoir can be sucked via a draft tube 8 and discharged to the upper reservoir, whereby the Francis turbine 100 is enabled to operate in a pumping mode (perform a pumping operation) as a pump turbine. In this operation, the degree of opening of the guide vanes 4 can be changed in accordance with a pump head to provide an appropriate pump discharge. The draft tube 8 according to the present embodiment corresponds to a tube portion.

The draft tube 8 is provided downstream of the runner 5 during turbine operation. The draft tube 8 is coupled to the lower reservoir or a spillway (not illustrated) and allows the water that has driven and rotated the runner 5 to restore its pressure and be discharged to the lower reservoir or the spillway. The draft tube 8 is generally provided with a draft-tube maintenance hole 21 for observation.

### (Transmissive Window Portion)

The draft tube 8 according to the present embodiment is provided with a transmissive window portion 22. The transmissive window portion 22 according to the present embodiment is provided in the draft tube 8 on the extension line of the axis of rotation X. The transmissive window portion 22 has, as at least a part thereof, a transparent member through which a communication signal passes. That is, the transmissive window portion 22 is obtained by forming a portion of a wall surface of the draft tube on the extension line of the axis of rotation X as an optically transmissive window. A material having a transmittance of 90% or more, such as glass and a transparent resin, is used as the material for the transmissive window portion 22. Further, a high-pressure resistant material having a refractive index of close to 1.33 is used as the material for the transmissive window portion 22. More specifically, in a case of using visible light as communication radio waves, a high-transmittance material such as glass, an acrylic resin, and polycarbonate, or a polymerized fluorine monomer material that is equal to water in refractive index can be used as the material for the transmissive window portion 22.

### (Hydraulic Device Measurement Apparatus)

The hydraulic device measurement apparatus 25 can measure surface strain or stress in the runner 5 that is a measurement target. This hydraulic device measurement apparatus 25 includes a first wireless communication portion 30 and a second wireless communication portion 40. The first wireless communication portion 30 is fixed to the runner cone with a support member (not illustrated).

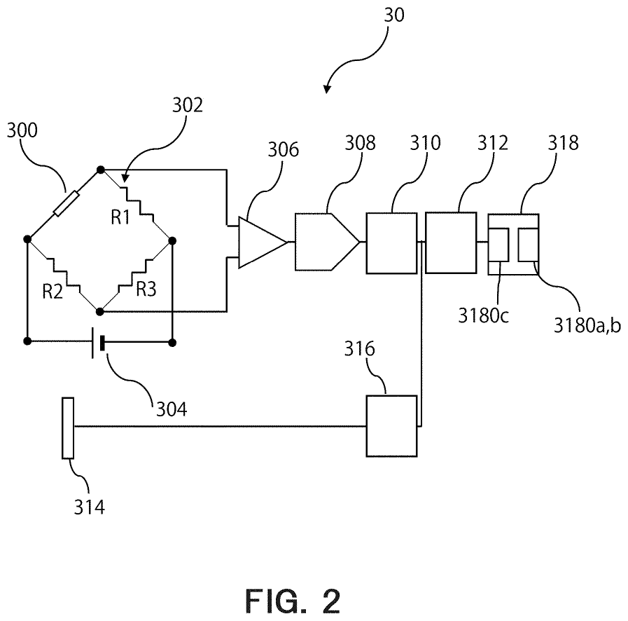

FIG. 2 is a diagram illustrating a configuration example of the first wireless communication portion 30. The first wireless communication portion 30 transfers measurement data from the underwater rotation side to the air side in the form of a propagated signal. The first wireless communication portion 30 can receive the propagated signal and convert it to an electrical signal. The distance between a transmitter/receiver of the first wireless communication portion 30 and a transmitter/receiver of the second wireless communication portion 40 is 10 mm or more and is different from the distance of so-called near-field wireless communication.

The first wireless communication portion 30 includes a measurement sensor 300, an electrical circuit 302, a direct-current power supply 304, an amplifier 306, an AD converter 308, a data recorder 310, a network protocol converter 312, a first wireless communicator 318, an imaging device 314, and an imaging controller 316. The first wireless communication portion 30 is arranged in a hollow space formed in the runner cone 20, that is, an inner space of the truncated cone portion, for example.

The measurement sensor 300 measures surface strain or stress in the runner 5. The measurement sensor 300 is bonded to at least one position on the surface of the runner 5, for example.

The electrical circuit 302 is, for example, a bridge circuit. One end of a first resistor R1 is connected to one end of the measurement sensor 300, and one end of a second resistor R2 is connected to the other end of the measurement sensor 300. Further, one end of a third resistor R3 is connected to the other end of the first resistor R1, and the other end of the second resistor R2 is connected to the other end of the third resistor. The direct-current power supply 304 is connected to the other end of the measurement sensor 300 and the other end of the first resistor R1. The amplifier 306 is connected to the one end of the measurement sensor 300 and the other end of the second resistor R2. With this configuration, measurement data of the measurement sensor 300 is amplified by the amplifier 306 as an analog voltage measurement signal. The measurement sensor 300, the electrical circuit 302, the direct-current power supply 304, the amplifier 306, and the AD converter 308 configure a measurement portion. Although the measurement portion according to the present embodiment measures surface strain or stress, the measurement target by the measurement portion is not limited thereto. For example, the measurement portion may be a device that can acquire measurement data such as a pressure, a temperature, and vibration in the runner 5.

The AD converter 308 is connected to the amplifier 306 and converts the amplified analog measurement signal to a digital measurement signal. The data recorder 310 is connected to the AD converter 308 and records therein the digital measurement signal in time series. The network protocol converter 312 converts the data recorded in the data recorder 310 to a network protocol format and supplies it to the first wireless communicator 318.

The imaging device 314 is a camera that is fixed in the runner cone 20 and can take a still image and a video. The imaging controller 316 controls imaging by the imaging device 314. Image data captured by the imaging device 314 is recorded in the data recorder 310 in time series in accordance with control by the imaging controller 316.

The first wireless communicator 318 is arranged in the runner cone that is a rotating portion rotating about the axis of rotation X in the Francis turbine 100 that is a hydraulic device. The first wireless communicator 318 can transmit measurement data related to the Francis turbine 100 in a wireless manner through a liquid, for example, water during rotation of the runner cone 20. More specifically, the first wireless communicator 318 according to the present embodiment includes a transmitter 3180a that transmits laser light, a receiver 3180b that receives laser light, and a controller 3180c that controls the transmitter 3180a and the receiver 3180b. For example, a laser that is excellent in high-speed communication performance and has a divergence angle of less than 20° can be used as a light source mounted on the transmitter 3180a. In the present embodiment, the transmitter 3180a and the receiver 3180b may be referred to as a transmitter/receiver 3180a, b collectively.

The transmitter 3180a in the first wireless communicator 318 converts an electrical signal to an optical signal and transmits the optical signal as laser light. The optical axis of the laser light transmitted by the transmitter 3180a is coincident with the axis of rotation X of the runner cone 20. Therefore, the optical axis is not shifted even when the runner cone 20 is rotated, so that a transmission signal can be transmitted more stably. The laser light transmitted by the transmitter 3180a travels straight in a liquid with its optical axis coincident with the axis of rotation X, and is transmitted to the second wireless communication portion 40 in air through the transmissive window portion 22. Further, since the laser light transmitted by the transmitter 3180a travels straight with its optical axis coincident with the axis of rotation X, signal fluctuation is prevented. Therefore, the range of the transmissive window portion 22 can be made smaller, whereby influences on the strength of the draft tube 8 can be further reduced. As described above, the first wireless communicator 318 converts a measurement signal from an electrical signal to an optical signal and emits the optical signal downstream along an optical axis centered on the axis of rotation X. The optical signal according to the present embodiment corresponds to a transfer signal.

The receiver 3180b in the first wireless communicator 318 can receive an optical signal. A photomultiplier tube can be used for the receiver 3180b, which converts the optical signal to an electrical signal. The controller 3180c in the first wireless communicator 318 supplies the electrical signal to the measurement portion, the imaging controller 316, and the like. Accordingly, the measurement portion and the imaging controller 316 are controlled based on information of a control signal included in the optical signal transmitted from the air side.

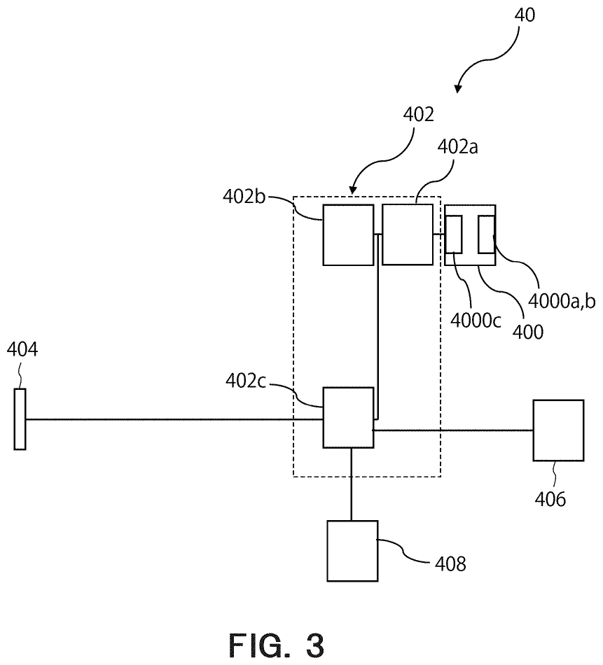

FIG. 3 is a diagram illustrating a configuration example of the second wireless communication portion 40. The second wireless communication portion 40 can be arranged and fixed on the air side. The air side according to the present embodiment means in the atmosphere outside the Francis turbine 100.

The second wireless communication portion 40 includes a second wireless communicator 400, a second network protocol converter 402a, a second data recorder 402b, a second imaging controller 402c, a second imaging device 404, a display 406, and an operating portion 408. The second network protocol converter 402a, the second data recorder 402b, and the second imaging controller 402c configure a control processing device 402. A general-purpose computer with a CPU can be used as the control processing device 402. That is, the control processing device 402 executes computer software stored in the data recorder 402b, thereby being able to implement respective control processing functions of the second network protocol converter 402a and the second imaging controller 402c.

The second wireless communicator 400 receives an optical signal transmitted by the first wireless communicator 318 and converts it to an electrical signal. The second wireless communicator 400 can also transmit an optical signal. More specifically, the second wireless communicator 400 according to the present embodiment includes a transmitter 4000a that transmits laser light, a receiver 4000b that receives laser light, and a controller 4000c that controls the transmitter 4000a and the receiver 4000b. For example, a laser that is excellent in high-speed communication performance and has a divergence angle of less than 20° can be used as a light source mounted on the transmitter 4000a. A photomultiplier tube can be used for the receiver 4000b. In the present embodiment, the transmitter 4000a and the receiver 4000b may be referred to as a transmitter/receiver 4000a, b collectively.

The transmitter 4000a in the second wireless communicator 400 converts an electrical signal to an optical signal and emits the optical signal as laser light. The optical axis of the laser light transmitted by the transmitter 4000a is coincident with the axis of rotation X of the runner cone 20. Therefore, the optical axis is not shifted even when the runner cone 20 is rotated, so that a transmission signal can be transmitted to the first wireless communication portion 30 more stably. As described above, the second wireless communicator 400 converts a measurement signal from an electrical signal to an optical signal and emits the optical signal upstream along an optical axis centered on the axis of rotation X. Accordingly, it is also possible to transmit a control signal from the control processing device 402 side to the first wireless communication portion 30 arranged in the runner cone 20 that is an underwater rotating body, as described above. Therefore, with the control signal converted by the first wireless communication portion 30 to an electrical signal, it is also possible to control the measurement sensor 300, the electrical circuit 302, the direct-current power supply 304, the amplifier 306, the AD converter 308, and the imaging controller 316, as described above.

The receiver 4000b in the second wireless communicator 400 is arranged on the extension line of the axis of rotation X. The receiver 4000b thus receives laser light that has travelled straight in a liquid along the axis of rotation X and has been transmitted to air through the transmissive window portion 22. The second wireless communicator 400 then converts the optical signal received by the receiver 4000b to an electrical signal and supplies it to the second network protocol converter 402a.

The second network protocol converter 402a converts the electrical signal supplied from the second wireless communicator 400 to a network protocol format and supplies it to the second data recorder 402b. The second data recorder 402b records therein the electrical signal supplied from the second network protocol converter 402a in time series.

The second imaging device 404 is a camera that can take a still image and a video. For example, the second imaging device 404 captures a picture in the draft tube 8 through the transmissive window portion 22.

The second imaging controller 402c controls imaging by the second imaging device 404. Image data captured by the second imaging device 404 is recorded in the second data recorder 402b in time series in accordance with control by the second imaging controller 402c. The second imaging controller 402c also controls the whole hydraulic device measurement apparatus 25. As described above, with the control signal from the second imaging controller 402c converted by the first wireless communication portion 30 to an electrical signal, it is possible to control the measurement sensor 300, the electrical circuit 302, the direct-current power supply 304, the amplifier 306, the AD converter 308, and the imaging controller 316.

The display 406 is, for example, a monitor and can display data in the second data recorder 402b via the second imaging controller 402c. The operating portion 408 is configured by a keyboard and a mouse, for example, and generates an operation signal for the second imaging controller 402c.

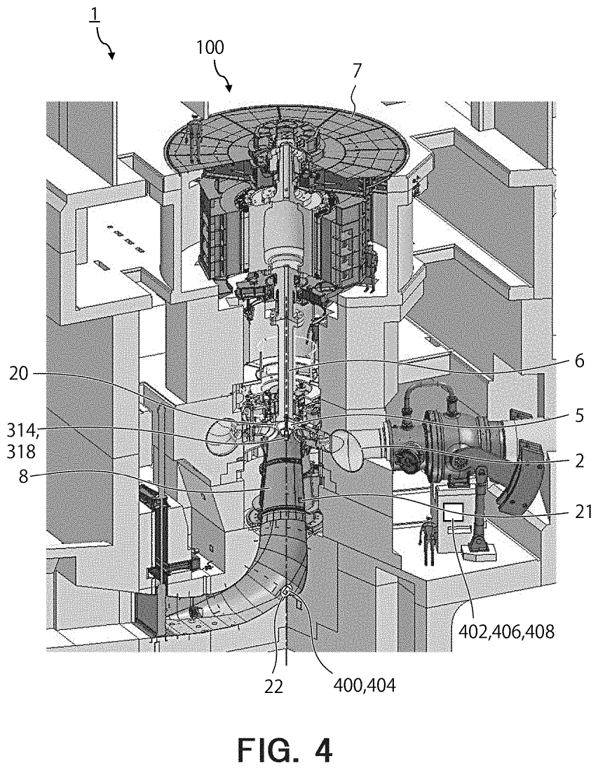

FIG. 4 is a perspective view of the hydraulic device measurement system 1 illustrated in FIG. 2. In the present embodiment, the strain and stress of the runner 5 of the Francis turbine 100 are measured, and integrity evaluation for the Francis turbine 100 as a hydraulic device is performed using a captured image as described above.

As described above, according to the present embodiment, the first wireless communicator 318 is fixed to the runner cone 20, and a transfer signal that can be communicated in a wireless manner through water is used. Accordingly, measurement data related to the runner 5 can be transmitted through the water to the air side even during rotation of the runner cone 20.

Further, according to the present embodiment, the optical axis of laser light transmitted by the transmitter 3180a in the first wireless communicator 318 is made coincident with the axis of rotation X of the runner cone 20, and the receiver 4000b in the second wireless communicator 400 is arranged on the extension line of the axis of rotation X. Accordingly, the optical axis is not shifted even when the runner cone 20 is rotated, so that a transmission signal during operation of the Francis turbine 100 can be transmitted more stably. Further, since the laser light transmitted by the transmitter 3180a travels straight with its optical axis coincident with the axis of rotation X, signal fluctuation is reduced. In this manner, the range of the transmissive window portion 22 can be made smaller. Consequently, influences on the strength of the draft tube 8 can be reduced further. As described above, without large modification of a device, for example, making the main shaft 6 hollow, decrease in measurement reliability, and large increase in cost, the measurement sensor 300 installed in the runner cone 20 that is an underwater rotating body inside the Francis turbine 100 can be operated from a non-rotating body in air outside the Francis turbine 100 (hydraulic device), so that necessary data can be acquired. Further, large capacity data can be transferred at a high speed from the runner cone 20 to the second wireless communicator 400 that is a non-rotating portion in air via the transmitter 3180a in water by using optical communication.

### Second Embodiment

The hydraulic device measurement system 1 according to a second embodiment is different from the hydraulic device measurement system 1 according to the first embodiment in that the receiver 4000b in the second wireless communicator 400 is arranged in the draft-tube maintenance hole 21 of the draft tube 8. Differences from the hydraulic device measurement system 1 according to the first embodiment are described below.

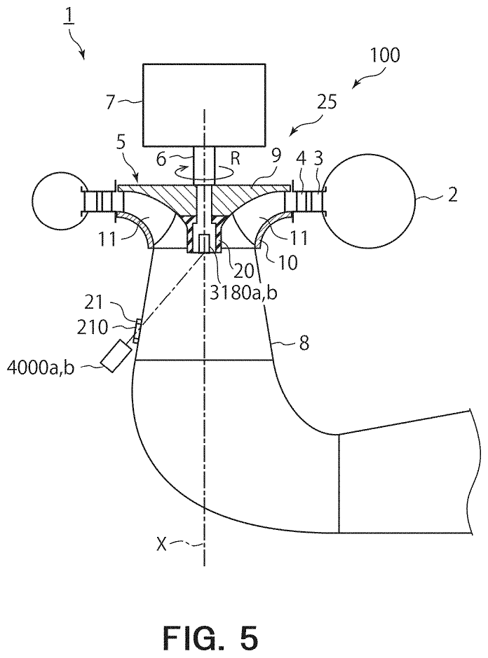

FIG. 5 is a diagram illustrating a configuration example of the hydraulic device measurement system according to the second embodiment. As illustrated in FIG. 5, a transmission range of an optical signal from the transmitter 3180a in the first wireless communicator 318 (see FIG. 2) is set to a range covering the draft-tube maintenance hole 21 of the draft tube 8.

The transmitter 3180a in the first wireless communicator 318 (see FIG. 2) includes, for example, an LED. LED light emitted from the transmitter 3180a is emitted conically to have a divergence angle of, for example, 20° or more about the axis of rotation X as an optical axis. In FIG. 5, the transmitter/receiver 3180a, b of the first wireless communication portion 30 and the transmitter/receiver 4000a, b of the second wireless communication portion 40 are illustrated, and illustrations of other constituent elements are omitted.

### (Transmissive Window Portion)

The draft-tube maintenance hole 21 according to the present embodiment is provided with a transmissive window portion 210. The transmissive window portion 210 according to the present embodiment is formed as an optically transmissive window in a range in the divergence angle of the LED in the first wireless communicator 318 on an extension line of a line connecting the transmitter in the first wireless communicator 318 and the draft-tube maintenance hole 21 to each other. A material having a transmittance of 90% or more, such as glass and a transparent resin, is used as a material for the transmissive window portion 210. In this manner, the transmissive window portion 210 can be provided in the draft-tube maintenance hole 21, so that it is unnecessary to process the draft tube 8. A high-pressure resistant material having a refractive index of close to 1.33 is used as the material for the transmissive window portion 210. In this manner, the transmissive window portion 210 can be provided in the draft-tube maintenance hole 21, so that it is unnecessary to process the draft tube 8. The receiver 3180b in the first wireless communicator 318 is also provided at the position equivalent to that of the transmitter 3180a.

A receiver in the second wireless communicator 400 (see FIG. 3) in the second wireless communication portion 40 is arranged on an extension line of a line connecting the transmitter in the first wireless communicator 318 (see FIG. 2) and the transmissive window portion 210 to each other. That is, the receiver in the second wireless communicator 400 is arranged in a range in the divergence angle of the LED in the first wireless communicator 318 on the extension line of the line connecting the transmitter in the first wireless communicator 318 and the transmissive window portion 210 to each other. The transmitter 4000a in the second wireless communicator 400 is also provided at the position equivalent to that of the receiver 4000b.

By providing the transmissive window portion 210 in the draft-tube maintenance hole 21 in this manner, the distance between the transmitter/receiver 3180a, b in the first wireless communicator 318 and the transmitter/receiver 4000a, b in the second wireless communicator 400 can be made shorter. This configuration also enables a lower-output light source to be used.

As described above, according to the present embodiment, the transmitter 3180a in the first wireless communicator 318 (see FIG. 2) emits LED light having a divergence angle of 20° or more conically with the center of its optical axis coincident with the axis of rotation X of the runner cone 20. Accordingly, an optical signal can be emitted to the existing draft-tube maintenance hole 21 stably even during rotation of the runner cone 20. Therefore, the transmissive window portion 210 can be provided in the existing draft-tube maintenance hole 21, so that it is unnecessary to process the draft tube 8. Further, the receiver 4000b in the second wireless communicator 400 (see FIG. 3) is arranged on an extension line of a line connecting the transmitter 3180a in the first wireless communicator 318 and the transmissive window portion 210 to each other. Accordingly, the optical signal is not shifted from the transmitter/receiver 4000a, b even when the runner cone 20 is rotated, so that a transmission/reception signal during operation of the Francis turbine 100 can be transmitted and received more stably.

### (First Modification of Second Embodiment)

A first modification of the second embodiment is different from the hydraulic device measurement system 1 according to the second embodiment in further including a portion of adjusting a transmission direction of the transmitter/receiver 3180a, b in the first wireless communicator 318 (see FIG. 2) and a portion of driving and rotating the transmitter/receiver 3180a, b. Differences from the hydraulic device measurement system 1 according to the second embodiment are described below.

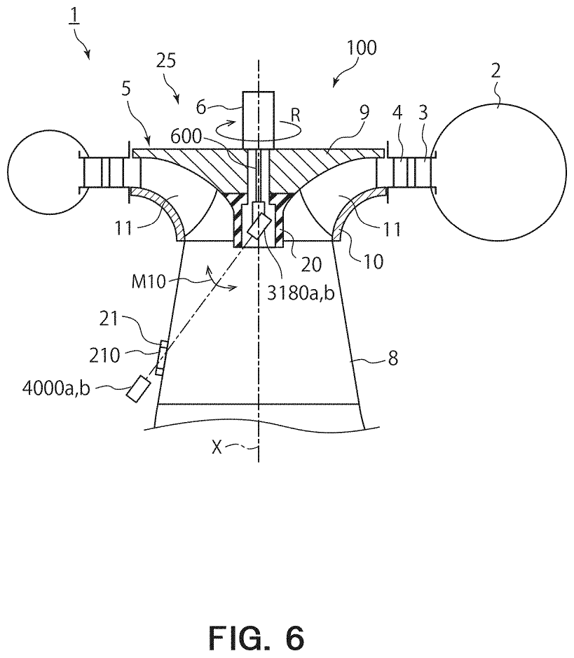

FIG. 6 is a diagram illustrating a configuration example of the hydraulic device measurement system 1 according to the first modification of the second embodiment. As illustrated in FIG. 6, the hydraulic device measurement apparatus 25 according to the first modification of the second embodiment further includes a driving portion 600. The driving portion 600 is fixed to the runner 5 with, for example, a bolt and holds the first wireless communicator 318 (see FIG. 2). The driving portion 600 includes a first driving motor that adjusts the orientation of the transmitter/receiver 3180a, b in the first wireless communicator 318 and a second driving motor that rotates the transmitter in the first wireless communicator 318 about the axis of rotation X of the runner cone 20 in the reverse direction. In FIG. 6, the transmitter/receiver 3180a, b of the first wireless communication portion 30 and the transmitter/receiver 4000a, b of the second wireless communication portion 40 are illustrated, and illustrations of other constituent elements are omitted. The first driving motor corresponds to an adjusting portion, and the second driving motor corresponds to a rotary driving portion.

The first driving motor can rotate the transmitter about a rotation axis perpendicular to the paper sheet in a direction of a mark M10. Accordingly, it is possible to transmit an optical signal to the receiver 4000b in the second wireless communicator 400 even in a case where the divergence angle of the transmitter 3180a is small.

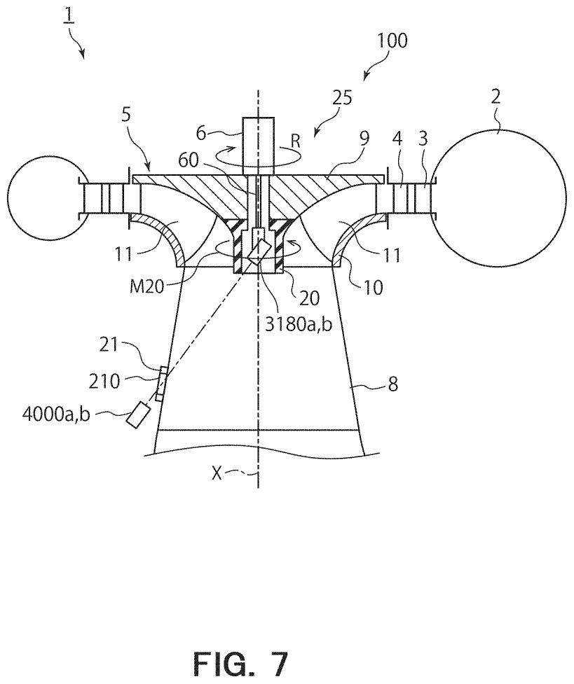

FIG. 7 is a diagram illustrating an example of horizontal rotation of the driving portion 600. Since the draft-tube maintenance hole 21 is provided in a specific section in the circumferential direction, light can reach only once per revolution of the runner 5, and therefore communication may be intermittent. Meanwhile, the driving portion 600 according to the present embodiment causes the transmitter 3180a to rotate about the axis of rotation X of the runner cone 20 in the reverse direction as illustrated with a mark M20. Accordingly, it is possible to always perform communication using an optical signal with the transmitter/receiver 4000a, b in the second wireless communicator 400 through the transmissive window portion 210 also when the main shaft 6 is rotated in the direction R. In FIG. 7, the transmitter/receiver 3180a, b of the first wireless communication portion 30 and the transmitter/receiver 4000a, b of the second wireless communication portion 40 are illustrated, and illustrations of other constituent elements are omitted.

### (Second Modification of Second Embodiment)

A second modification of the second embodiment is different from the hydraulic device measurement system according to the first modification of the second embodiment in including a plurality of the transmissive window portions 210 and a plurality of the transmitters/receivers 4000a, b in the second wireless communicators 400. Differences from the hydraulic device measurement system 1 according to the first modification of the second embodiment are described below.

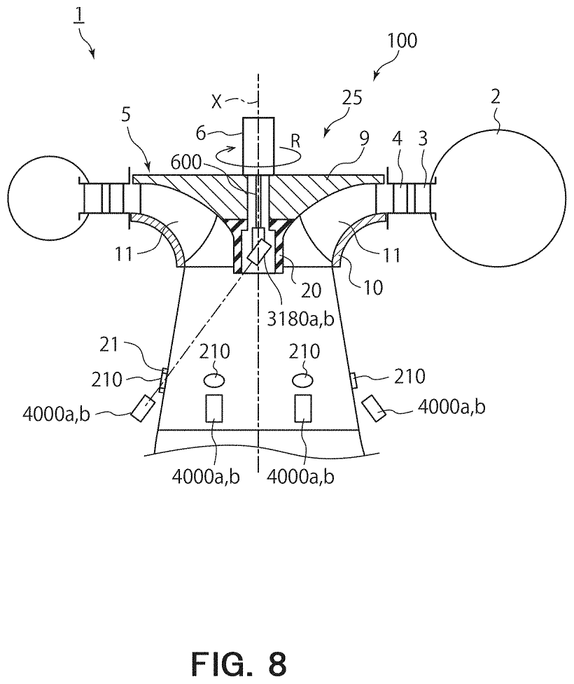

FIG. 8 is a diagram illustrating a configuration example of the hydraulic device measurement system 1 according to the second modification of the second embodiment. As illustrated in FIG. 8, the hydraulic device measurement apparatus 25 according to the second modification of the second embodiment includes the transmissive window portions 210 and the transmitters/receivers 4000a, b in the second wireless communicators 400. In FIG. 8, the transmitter/receiver 3180a, b of the first wireless communication portion 30 and the transmitters/receivers 4000a, b of the second wireless communication portions 40 are illustrated, and illustrations of other constituent elements are omitted.

The transmissive window portions 210 are three or more transmissive window portions provided on a plane perpendicular to the axis of rotation X. The second wireless communicators 400 respectively correspond to the transmissive window portions 210. The receiver 3180b in the first wireless communicator 318 is also provided at the position equivalent to that of the transmitter 3180a. The transmitters 4000a in the second wireless communicators 400 are also provided at the positions equivalent to those of the receivers 4000b.

The transmitter 3180a in the first wireless communicator 318 (see FIG. 2) according to the second modification of the second embodiment includes, for example, an LED. LED light emitted from the transmitter 3180a is emitted conically to have a divergence angle of, for example, 15° or more around the axis of rotation X as an optical axis. Accordingly, at least two of the second wireless communicators 400 always receive an optical signal through at least two of the transmissive window portions 210. As is apparent from this description, the optical signal can always be transmitted and received even when the driving portion 600 does not rotate the transmitter 3180a in the first wireless communicator 318 (see FIG. 2) in the reverse direction about the axis of rotation X of the runner cone 20.

### Third Embodiment

The hydraulic device measurement system 1 according to a third embodiment is different from the hydraulic device measurement system 1 according to the first embodiment in that the transmitter/receiver 4000a, b in the second wireless communicator 400 transmits and receives an optical signal via a light guide tube 50. Differences from the hydraulic device measurement system 1 according to the first embodiment are described below.

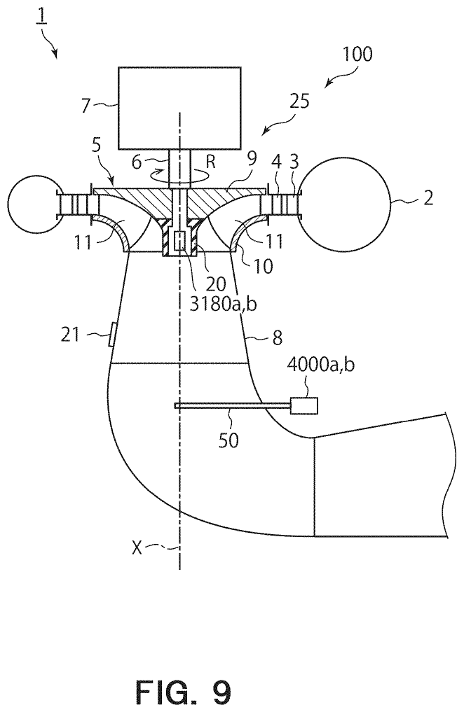

FIG. 9 is a diagram illustrating a configuration example of the hydraulic device measurement system according to the third embodiment. As illustrated in FIG. 9, the transmitter/receiver 4000a, b in the second wireless communicator 400 transmits and receives an optical signal via the light guide tube 50. In FIG. 9, the transmitter/receiver 3180a, b of the first wireless communication portion 30 and the transmitter/receiver 4000a, b of the second wireless communication portion 40 are illustrated, and illustrations of other constituent elements are omitted.

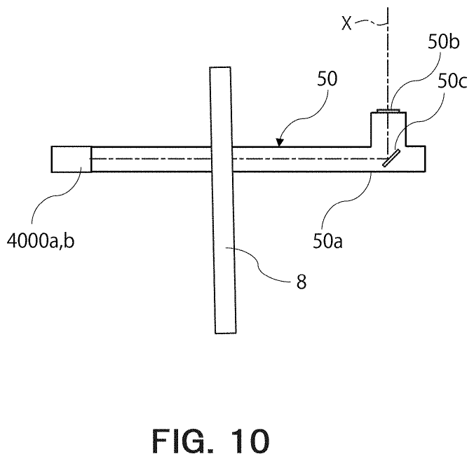

FIG. 10 is a diagram illustrating a configuration example of the light guide tube 50. The light guide tube 50 includes a barrel 50a, a transparent portion 50b, and a mirror surface 50c. The barrel 50a holds the transparent portion 50b, the mirror surface 50c, and the transmitter/receiver 4000a, b in the second wireless communicator 400. In FIG. 10, the transmitter/receiver 4000a, b of the second wireless communication portion 40 is illustrated, and illustrations of other constituent elements are omitted.

The transparent portion 50b is arranged on the extension line of the axis of rotation X, that is, an optical axis of the transmitter in the first wireless communicator 318. A material having a transmittance of 90% or more, such as glass and a transparent resin, is used as the material for the transparent portion 50b. Further, a high-pressure resistant material having a refractive index of close to 1.33 is used as the material for the transparent portion 50b.

The mirror surface 50c is a reflecting mirror and changes the direction of the optical axis of the transmitter/receiver 3180a, b by 90°. The transmitter/receiver 4000a, b in the second wireless communicator 400 is arranged on the extension line of the changed optical axis. Accordingly, the optical signal is not shifted from the transmitter/receiver 4000a, b even when the runner cone 20 is rotated, so that a transmission/reception signal during operation of the Francis turbine 100 can be transmitted and received more stably.

Further, during operation of the Francis turbine 100, the light guide tube 50 is retracted in such a manner that its tip is located near the wall surface of the draft tube 8. When real-time measurement is required, for example, the light guide tube 50 can be inserted to the axis of rotation X. Therefore, the light guide tube 50 includes a driving device that can adjust its own position in the radial direction. Accordingly, when monitoring is not performed, it is possible to bring the light guide tube 50 close to the wall surface of the draft tube 8. Consequently, influences on a water flow can also be reduced.

### Fourth Embodiment

The hydraulic device measurement system 1 according to a fourth embodiment is different from the hydraulic device measurement system 1 according to the first embodiment in that the transmitter/receiver 4000a, b in the second wireless communicator 400 is arranged in a second light guide tube 60. Differences from the hydraulic device measurement system 1 according to the first embodiment are described below.

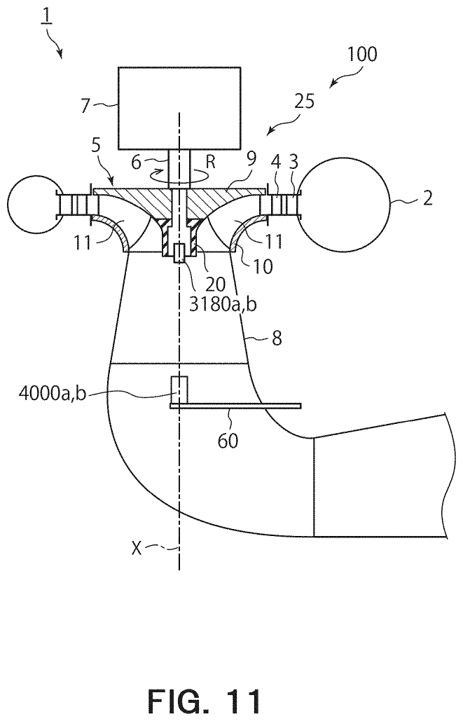

FIG. 11 is a diagram illustrating a configuration example of the hydraulic device measurement system according to the fourth embodiment. As illustrated in FIG. 11, the transmitter/receiver 4000a, b in the second wireless communicator 400 is arranged in the second light guide tube 60. In FIG. 11, the transmitter/receiver 3180a, b of the first wireless communication portion 30 and the transmitter/receiver 4000a, b of the second wireless communication portion 40 are illustrated, and illustrations of other constituent elements are omitted.

The transmitter/receiver 4000a, b in the second wireless communicator 400 is arranged on the extension line of the axis of rotation X, that is, an optical axis of the transmitter when real-time measurement is required. Accordingly, an optical signal is not shifted from the transmitter/receiver 4000a, b even when the runner cone 20 is rotated, so that a transmission/reception signal during operation of the Francis turbine 100 can be transmitted and received more stably. Further, the second light guide tube 60 is configured to be movable relative to the wall surface of the draft tube 8. Therefore, when monitoring is not performed, it is possible to bring the second light guide tube 60 close to the wall surface of the draft tube 8. Consequently, influences on a water flow can also be reduced.

### Fifth Embodiment

The hydraulic device measurement system 1 according to a fifth embodiment is different from the hydraulic device measurement system 1 according to the first embodiment in that an optical signal emitted from the transmitter 4000a in the second wireless communicator 400 can be emitted through a cylindrical lens 412. Differences from the hydraulic device measurement system 1 according to the first embodiment are described below.

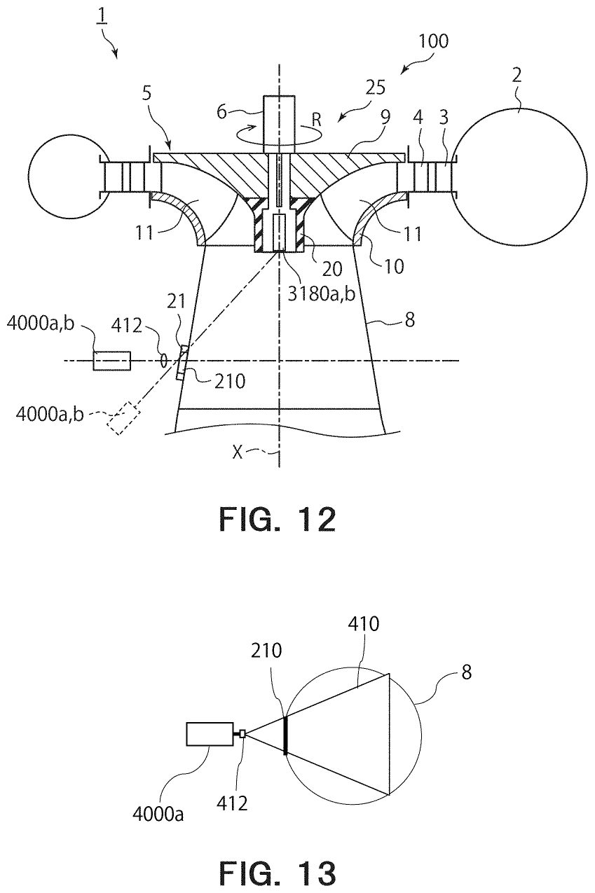

FIG. 12 is a diagram illustrating a configuration example of the hydraulic device measurement system 1 according to the fifth embodiment. As illustrated in FIG. 12, the transmitter 4000a in the second wireless communicator 400 changes the direction of emission to the horizontal direction and emits light through the cylindrical lens 412, when being used in measurement. In other words, as illustrated with a broken line, the transmitter 4000a in the second wireless communicator 400 emits an optical signal toward the receiver 3180a in the first wireless communicator 318, not through the cylindrical lens 412, when performing communication. That is, the transmitter 4000a in the second wireless communicator 400 according to the fifth embodiment includes a rotary driving portion (not illustrated). In FIG. 12, the transmitter/receiver 3180a, b of the first wireless communication portion 30 and the transmitter/receiver 4000a, b of the second wireless communication portion 40 are illustrated, and illustrations of other constituent elements are omitted.

FIG. 13 is a top view illustrating a state where the transmitter 4000a in the second wireless communicator 400 emits laser light through the cylindrical lens 412. The imaging portion 314 can capture sheet light 410 illustrated in FIG. 13 and perform imaging. Accordingly, the state of water flowing through the draft tube 8 can be observed.

### Sixth Embodiment

Although visible light such as laser light and LED light is used as oscillating light of the hydraulic device measurement apparatus 25 according to each of the first to fifth embodiments, the hydraulic device measurement apparatus 25 according to a sixth embodiment is different therefrom in using a conducted wave in a wavelength band different from a visible wavelength band, for example, ultraviolet rays or X-rays. Differences from the hydraulic device measurement apparatus 25 according to each of the first to fifth embodiments are described below.

### (Transmissive Window Portion)

In a case of using X-rays or ultraviolet rays, for example, as communication radio waves, the transmissive window portion 22 (see FIG. 1 and the like) is formed by a transparent member through which these radio waves can pass. More specifically, in a case of using ultraviolet rays as the communication radio waves, float plate glass can be used as a transmissive-window material forming the transmissive window portion 22. Furthermore, in a case of using X-rays as the communication radio waves, beryllium can be used as the transmissive-window material forming the transmissive window portion 22.

The transmitter 3180a in the first wireless communicator 318 (see FIG. 2) converts an electrical signal to a transfer signal and transmits ultraviolet rays or X-rays as the transfer signal. Ultraviolet rays and X-rays are 100 to 1000 times higher in energy than visible light, for example, and can perform communication at a higher speed. Similarly, the transmitter 4000a in the second wireless communicator 400 (see FIG. 3) converts an electrical signal to a transfer signal and transmits ultraviolet rays or X-rays as the transfer signal.

Further, the receiver 3180b in the first wireless communicator 318 (see FIG. 2) converts the transfer signal of ultraviolet rays or X-rays to an electrical signal. Similarly, the receiver 4000b in the second wireless communicator 400 (see FIG. 3) converts the transfer signal of ultraviolet rays or X-rays to an electrical signal.

As described above, the hydraulic device measurement apparatus according to the sixth embodiment uses a conducted wave in a wavelength band different from a visible wavelength band, for example, ultraviolet rays or X-rays for a transfer signal. Accordingly, it is possible to make energy of the transfer signal 100 to 1000 times higher than that of visible light, thereby enabling communication to be performed at a higher speed.

While certain embodiments of the present invention have been described, these embodiments have been presented by way of example only, and are not intended to limit the scope of the inventions. Indeed, the novel embodiments described herein may be embodied in a variety of other forms; furthermore, various omissions, substitutions, and changes may be made without departing from the spirit of the inventions. The embodiments and their modifications would fall within the scope and the spirit of the inventions and also in the accompanying claims and their equivalents.

1. A hydraulic device measurement apparatus comprising:
a first wireless communication portion arranged in a rotating portion of a hydraulic device rotatable in water about a rotation axis, and capable of performing wireless communication of a transfer signal through the water during rotation of the rotating portion, the transfer signal including information on measurement data related to the hydraulic device; and
a second wireless communication portion capable of performing wireless communication with the first wireless communication portion through the water, wherein
the second wireless communication portion is arranged in air and capable of performing communication through a transmissive window portion arranged along an extension line of a center line of the rotation axis,
a transmitter and a receiver of the first wireless communication portion are arranged along the rotation axis of the rotating portion, and a transmitter and a receiver of the second wireless communication portion are arranged in the air along the rotation axis, and
the first wireless communication portion and the second wireless communication portion transmit and receive the transfer signal along the rotation axis of the rotating portion.

2. The apparatus of claim 1, wherein the first wireless communication portion and the second wireless communication portion use at least any of visible light, X-rays, and ultraviolet rays as the transfer signal.

3. The apparatus of claim 1, wherein the transmitter and the receiver of the first wireless communication portion and the transmitter and the receiver of the second wireless communication portion perform the wireless communication through a distance of 10 mm or more.

4. A hydraulic device measurement apparatus comprising:
a first wireless communication portion arranged in a rotating portion of a hydraulic device rotatable in water about a rotation axis, and capable of performing wireless communication of a transfer signal through the water during rotation of the rotating portion, the transfer signal including information on measurement data related to the hydraulic device;
a second wireless communication portion capable of performing wireless communication with the first wireless communication portion through the water; and
a light guide tube including a mirror surface that can be arranged on an extension line of a center line of the rotation axis in a tube portion discharging the water, wherein
the second wireless communication portion receives a signal reflected by the mirror surface in air.

5. The apparatus of claim 4, wherein the mirror surface is moved toward a wall surface of the tube portion from the extension line of the central line of the rotation axis, when the first wireless communication portion and the second wireless communication portion perform no communication.

6. A hydraulic device measurement apparatus comprising:
a first wireless communication portion arranged in a rotating portion of a hydraulic device rotatable in water about a rotation axis, and capable of performing wireless communication of a transfer signal through the water during rotation of the rotating portion, the transfer signal including information on measurement data related to the hydraulic device;
a second wireless communication portion capable of performing wireless communication with the first wireless communication portion through the water; and
a second light guide tube capable of having a transmitter and a receiver of the second wireless communication portion arranged on an extension line of a center line of the rotation axis, wherein
the transmitter and the receiver of the second wireless communication portion are capable of performing communication in the water.

7. The apparatus of claim 6, wherein the transmitter and the receiver of the second wireless communication portion are moved toward a wall surface of a tube portion discharging the water from the extension line of the center line of the rotation axis when the first wireless communication portion and the second wireless communication portion perform no communication.

8. The apparatus of claim 1, wherein
the first wireless communication portion comprises:
a measurement portion configured to measure at least any of physical quantities related to the rotating portion, including stress, a temperature, and vibration; and
an imaging portion configured to capture an image related to the rotating portion,
the second wireless communication portion comprises a control processor configured to control at least either the measurement portion or the imaging portion, and
the wireless communication includes information on at least any of the physical quantities, data of the image captured by the imaging portion, and a control signal from the control processor.

9. The apparatus of claim 8, wherein the transmitter of the second wireless communication portion is capable of transmitting an optical signal into the water through a cylindrical lens.

10. A hydraulic device measurement system comprising:
the hydraulic device measurement apparatus of claim 1;
a tube portion of the hydraulic device, configured to discharge the water;
a runner of the hydraulic device, configured to rotate about the rotation axis; and
a runner cone of the hydraulic device, fixed to the runner and configured to rotate about the rotation axis, wherein
the rotating portion is the runner cone, and
the first wireless communication portion is arranged in an inner space of the runner cone.

11. The system of claim 10, further comprising a transmissive window portion provided at a crossing of an extension line of a center line of the rotation axis and the tube portion, wherein
the second wireless communication portion is arranged in the air and is capable of communicating with the first wireless communication portion through the transmissive window portion,
any of glass, an acrylic resin, and polycarbonate or a polymerized fluorine monomer material having a refractive index equal to that of the water is used as a material for the transmissive window portion when the wireless communication uses visible light,
a float plate glass is used as the material for the transmissive window portion when the wireless communication uses ultraviolet rays, and
beryllium is used as the material for the transmissive window portion when the wireless communication uses X-rays.

12. The system of claim 10, further comprising:
a driving portion configured to fix the first wireless communication portion to the runner cone and to drive and adjust orientations of a transmitter and a receiver of the first wireless communication portion; and
a transmissive window portion provided in the tube portion, wherein
the driving portion directs the transfer signal used for communication by the transmitter and the receiver to the transmissive window portion.

13. The system of claim 10, wherein three or more transmissive window portions are included which are provided in a wall surface of the tube portion on a plane perpendicular to the rotation axis,
a plurality of the receivers of the second wireless communication portions are included to respectively correspond to the three or more transmissive window portions, and
the transmitter of the first wireless communication portion is fixed to the runner cone and transmits a transfer signal to at least two of the three or more transmissive window portions.
